(19) United States
(12) Patent Application Publication
(10) Pub. No.: US 2022/0073794 A1
(43) Pub. Date: Mar. 10, 2022

(54) ANTISTATIC LAMINATE AND ANTISTATIC ADHESIVE AGENT

(71) Applicant: 3M INNOVATIVE PROPERTIES COMPANY, St. Paul, MN (US)

(72) Inventors: Shunsuke Suzuki, Tokyo (JP); Jiro Hattori, Kanagawa (JP); Koji Hasumi, Tokyo (JP)

(21) Appl. No.: 17/418,587

(22) PCT Filed: Dec. 20, 2019
(86) PCT No.: PCT/IB2019/061209

§ 371 Date: Jun. 25, 2021

(30) Foreign Application Priority Data
Dec. 26, 2018 (JP) 2018-243169

(51) Int. Cl. C09J 133/10; C09J 133/06; C09J 9/00

(52) U.S. Cl. CPC C09J 133/10; C09J 133/068; C09J 7/385; C09J 2479/086; C09J 9/00

(57) ABSTRACT

To provide an antistatic laminate and an antistatic adhesive agent capable of maintaining antistatic performance and adhesive force necessary during high-temperature heat treatment, easily removable from an adherend after heat treatment, and capable of reducing or eliminating contaminants such as an antistatic agent and an adhesive agent residue present on an adherend obtained after the removal.

### TECHNICAL FIELD

The present disclosure relates to an antistatic laminate and an antistatic adhesive agent.

### BACKGROUND ART

A heat treatment step is generally used in production of various types of electronic components, and in some cases, heat treatment at 100° C. or greater is performed several times to cure or age a material. An adhesive tape having heat resistance, which is sometimes called a process tape, is used for the purpose of securing an article to be treated, such as an epoxy resin-sealed silicon wafer or a plastic resin laminated copper plate provided in an electronic component, on a work surface within a device during heat treatment and, as necessary, for the purpose of transporting such an article after the heat treatment. After the heat treatment is complete, the process tape is removed from the article to be treated.

In some cases, electrostatic discharge (ESD) causes a significant failure in a functional sensor chip. In particular, a surface acoustic wave band filter (SAW filter) is extremely sensitive to ESD. A process tape generally includes a resin film of polyethylene terephthalate, polyimide, or the like and an acrylic-based adhesive layer, a silicone-based adhesive layer, or the like. Since any of these is an insulating organic material, there is a risk of generating a relatively large amount of ESD during heat treatment. For this reason, it has been attempted to impart an antistatic property to a process tape used in a device sensitive to ESD.

Patent Literature 1 (JP 2013-076081A) describes an “antistatic composition including a melt blend of at least one type of ionic salt (a) including a non-polymeric nitrogen onium cation and a weakly coordinating fluorine-containing organic anion, wherein a conjugate acid of the anion is a superacid; and at least one type of thermoplastic polymer (b).”

Patent Literature 2 (JP 2012-001737A) describes an “adhesive agent composition containing main components of an ionic liquid and, as a base polymer, a (meth)acrylic polymer including at least one type of (meth)acrylate having a glass transition temperature (Tg) of not greater than 0° C. and containing an alkyl group having from 1 to 14 carbon atoms, wherein an anion component of the ionic liquid includes a sulfonate anion or a sulfate ester anion.”

Patent Literature 3 (JP 2007-070400A) describes an “adhesive agent composition containing an ionic liquid and, as a base polymer, a polymer having a glass transition temperature (Tg) of not greater than 0° C., wherein an anion component of the ionic liquid includes a sulfonate anion or a sulfate ester anion.”

Patent Literature 4 (JP 2007-092057A) describes an “adhesive agent composition containing an ionic liquid, and a polymer containing, as a monomer unit, (meth)acrylic acid ester containing a hydroxyalkyl group having from 3 to 12 carbon atoms, in an amount of 0.1 to 10 wt. %.”

### CITATION LIST

### Patent Literature

Patent Literature 1: JP 2013-076081A

Patent Literature 2: JP 2012-001737A

Patent Literature 3: JP 2007-070400A

Patent Literature 4: JP 2007-092057A

### SUMMARY OF INVENTION

In some cases, owing to bleeding of an antistatic agent during a high-temperature heat treatment step of greater than 200° C., the antistatic agent is lost from an adhesive layer, and antistatic performance of a known process tape decreases. Furthermore, in some cases, owing to bleeding of the antistatic agent onto an adhesive layer surface during heat treatment, when the heat treatment is performed and subsequently the process tape is removed from an article to be treated, the antistatic agent adheres to a surface of the article to be treated, and contaminates the surface. Further, a process tape capable of securing an adherend to a work surface even at high temperature and easily removable after heat treatment is desired.

The present disclosure provides an antistatic laminate and an antistatic adhesive agent capable of maintaining antistatic performance and adhesive force necessary during high-temperature heat treatment, easily removable from an adherend after heat treatment, and capable of reducing or eliminating contaminants such as an antistatic agent and an adhesive agent residue present on the adherend obtained after the removal.

### Solution to Problem

According to an embodiment, provided is an antistatic laminate including a substrate and an adhesive layer, wherein the adhesive layer includes: a (meth)acrylic tacky adhesive polymer; a self-crosslinking (meth)acrylic copolymer containing an epoxy group and an epoxy group-reactive functional group; and an ionic liquid containing an epoxy group-reactive functional group, and the adhesive layer includes a sea-island structure including a sea containing the (meth)acrylic tacky adhesive polymer and an island containing the self-crosslinking (meth)acrylic copolymer.

According to another embodiment, provided is an antistatic adhesive agent including: a (meth)acrylic tacky adhesive polymer; a self-crosslinking (meth)acrylic copolymer containing an epoxy group and an epoxy group-reactive functional group; and an ionic liquid containing an epoxy group-reactive functional group, wherein when the antistatic adhesive agent is solidified or dried on a substrate, the antistatic adhesive agent forms a sea-island structure including a sea containing the (meth)acrylic tacky adhesive polymer and an island containing the self-crosslinking (meth)acrylic copolymer.

### Advantageous Effects of Invention

An antistatic laminate and an antistatic adhesive agent of the present disclosure are capable of maintaining antistatic performance and adhesive force necessary during high-temperature heat treatment, easily removable from an adherend after heat treatment, and capable of reducing or eliminating contaminants such as an antistatic agent and an adhesive agent residue present on the adherend obtained after the removal.

The above description should not be construed as disclosing all embodiments of the present invention and all advantages relating to the present invention.

### BRIEF DESCRIPTION OF DRAWINGS

FIG. 1 is a schematic cross-sectional view of an antistatic laminate of an embodiment.

FIG. 2 is a schematic cross-sectional view of an antistatic laminate of another embodiment.

### DESCRIPTION OF EMBODIMENTS

For the purpose of exemplifying typical embodiments of the present invention, the typical embodiments of the present invention will be described in detail below with reference to the drawings, but the present invention is not limited to these embodiments.

In the present disclosure, the term “film” encompasses articles referred to as “sheets”.

In the present disclosure, “pressure sensitive adhesion” refers to the characteristic of a material or composition that is permanently adhesive in the temperature range of usage, such as from 0° C. to 50° C., and that adheres to various surfaces with light pressure and does not exhibit a phase change (from liquid to solid).

In the present disclosure, the term “(meth)acrylic” refers to acrylic or methacrylic, and the term “(meth)acrylate” refers to acrylate or methacrylate.

The antistatic laminate of an embodiment includes a substrate and an adhesive layer. The adhesive layer includes a (meth)acrylic tacky adhesive polymer, a self-crosslinking (meth)acrylic copolymer containing an epoxy group and an epoxy group-reactive functional group (also referred to simply as a “self-crosslinking (meth)acrylic copolymer” in the present disclosure), and an ionic liquid containing an epoxy group-reactive functional group. The adhesive layer includes a sea-island structure including a sea containing the (meth)acrylic tacky adhesive polymer and an island containing the self-crosslinking (meth)acrylic copolymer. During heat treatment, the epoxy group-reactive functional group of the ionic liquid reacts with the epoxy group of the self-crosslinking (meth)acrylic copolymer to form a chemical bond between the ionic liquid and the self-crosslinking (meth)acrylic copolymer. As a result, bleeding of the ionic liquid from the adhesive layer can be suppressed, and an antistatic property can be maintained even in a high-temperature environment. Furthermore, generation of an adhesive agent residue associated with the bleeding of the ionic liquid can be suppressed, and when heat treatment is performed and subsequently an adherend is peeled from the adhesive layer, an adhesive agent residue present on the adherend can be reduced or eliminated effectively.

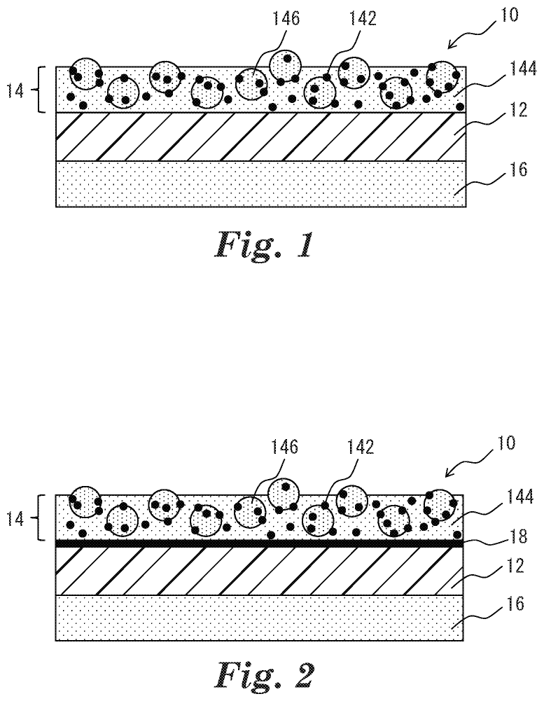

FIG. 1 is a schematic cross-sectional view of an antistatic laminate of an embodiment. An antistatic laminate 10 includes a substrate 12 and an adhesive layer 14. The adhesive layer 14 includes an ionic liquid 142 containing an epoxy group-reactive functional group. The adhesive layer 14 includes a sea-island structure including a sea 144 containing a (meth)acrylic tacky adhesive polymer and an island 146 containing a self-crosslinking (meth)acrylic copolymer. In FIG. 1, the ionic liquid 142 containing an epoxy group-reactive functional group is indicated by a black circle as an molecule, but the ionic liquid 142 is dissolved or dispersed in the adhesive layer 14. During heat treatment, the ionic liquid 142 forms a chemical bond with the self-crosslinking (meth)acrylic copolymer and is secured to the adhesive layer. The substrate 12 may optionally include a second adhesive layer 16 on a surface of the side opposite to a surface on which the adhesive layer 14 is disposed. In FIG. 1, the antistatic laminate 10 is illustrated as a two-sided adhesive laminate.

Examples of the substrate that can be used include a film containing polyester such as polyethylene terephthalate and polyethylene naphthalate, an acrylic resin such as polyurethane, polyimide, polycarbonate, polyether ether ketone, polyphenylene sulfide, polyether sulfone, polyethylene sulfide, polyphenylene ether, and polymethyl methacrylate, or a fluororesin such as polyvinylidene fluoride, polyethylene tetrafluoride, and polychloro-trifluoroethylene, or a laminated film thereof; paper such as kraft paper and Japanese paper; fabric and nonwoven fabric containing polyester fiber, polyamide fiber, carbon fiber, or the like; a rubber sheet containing natural rubber, butyl rubber, or the like; a foam sheet containing polyurethane, polychloroprene rubber or the like; metal foil such as aluminum foil, copper foil, and the like; or a composite thereof.

The substrate desirably has a glass transition temperature of not less than approximately 100° C., not less than approximately 110° C., or not less than approximately 120° C. Owing to the glass transition temperature of the substrate being not less than approximately 100° C., deformation of the substrate during heat treatment can be suppressed and an adherend can be secured stably. In an embodiment, the glass transition temperature of the substrate is not greater than approximately 300° C., not greater than approximately 250° C., or not greater than approximately 200° C.

From the perspective of heat resistance, availability, and handleability, the substrate is desirably a film of polyethylene terephthalate, polyethylene naphthalate, polyimide, polyether sulfone, or polyphenylene sulfide, and in application requiring higher heat resistance, the substrate is more desirably a polyimide film.

The substrate may be transparent, semi-transparent, or opaque.

For the purpose of improving an adhesive property between the adhesive layer and the second adhesive layer, surface treatment such as corona discharge treatment, plasma treatment, chromic acid treatment, flame treatment, ozone treatment, and sand blasting may be performed on the one surface or both the surfaces of the substrate, and a primer layer may be formed.

An electrically conductive layer may be disposed on the one surface or both the surfaces of the substrate. Owing to the presence of the electrically conductive layer, an antistatic property of the antistatic laminate can be further increased and discharge mitigation can be promoted. The electrically conductive layer is desirably disposed between the substrate and the adhesive layer. As a result, movement of an electrostatic charge from the adhesive layer to the electrically conductive layer can further be promoted. The electrically conductive layer contains, for example, a metal or a metal oxide of aluminum, titanium, copper, palladium, silver, gold, or the like, or an ion-conductive substance. The electrically conductive layer can be formed by a method such as laminating metal foil on a substrate, depositing a metal thin film by sputtering, vapor deposition, or the like on a substrate surface, and applying and drying a dispersion liquid or a solution of the metal, the metal oxide, or the ion-conductive substance described above on the substrate surface to form a coating layer. The metal, the metal oxide, and the ion-conductive substance may be secured on the substrate surface via another organic binder, an adhesive layer, a glass body, or the like.

FIG. 2 is a schematic cross-sectional view of the antistatic laminate of this embodiment. The antistatic laminate 10 includes the substrate 12, the adhesive layer 14, and an electrically conductive layer 18, and the electrically conductive layer 18 is disposed between the substrate 12 and the adhesive layer 14.

In an embodiment, a thickness of the electrically conductive layer is not less than approximately 10 nm, not less than approximately 20 nm, or not less than approximately 100 nm, and not greater than approximately 10 μm, not greater than approximately 3 μm, or not greater than approximately 1 μm.

In an embodiment, surface resistance of the electrically conductive layer is, as measured under conditions of 23° C. and relative humidity of 55%, not less than approximately 0.01 kΩ/□, not less than approximately 0.1 kΩ/□, or not less than approximately 1 kΩ/□, and not greater than approximately 1000 kΩ/□, not greater than approximately 500 kΩ/□, or not greater than approximately 100 kΩ/□.

The substrate may have release treatment. In this embodiment, the substrate functions as a release liner, and after one surface of the adhesive layer of the antistatic laminate is bonded to an adherend or to a surface on which the adherend is secured, the substrate is removed. An exposed other surface of the adhesive layer is bonded to the surface on which the adherend is secured or to the adherend and thus, the adherend and the surface on which the adherend is secured can be adhered to each other via the adhesive layer. The release treatment can be performed by applying a release agent containing silicone, a long-chain alkyl compound, a fluorine compound, or the like to the substrate or by dipping the substrate in such a release agent.

A thickness of the substrate can typically be not less than approximately 5 μm, not less than approximately 10 μm, or not less than approximately 20 μm, and not greater than approximately 1 mm, not greater than approximately 500 μm, or not greater than approximately 250 μm.

The adhesive layer can be formed by applying an antistatic adhesive agent including a (meth)acrylic tacky adhesive polymer, a self-crosslinking (meth)acrylic copolymer, an ionic liquid containing an epoxy group-reactive functional group, and, as necessary, a crosslinking agent, an additive, a solvent, and the like to the substrate by using a knife coater, a bar coater, a blade coater, a doctor coater, a roll coater, a cast coater, melt extrusion or the like, and solidifying or drying the antistatic adhesive agent on the substrate. The antistatic adhesive agent may be of a solvent type, a solventless type, or a hot melt type. When the antistatic adhesive agent is solidified or dried on the substrate, a sea-island structure including a sea containing the (meth)acrylic tacky adhesive polymer and an island containing the self-crosslinking (meth)acrylic copolymer is formed. The solidification includes curing the antistatic adhesive agent by heating, ultraviolet light irradiation, or the like, and hardening by cooling a hot melt antistatic adhesive agent. The drying includes evaporation of a solvent.

From the perspective of workability, the adhesive layer is advantageously a pressure sensitive adhesive layer.

The (meth)acrylic tacky adhesive polymer mainly constitutes the sea of the sea-island structure. The (meth)acrylic tacky adhesive polymer may be present in the island of the sea-island structure. The (meth)acrylic tacky adhesive polymer provides adhesive force to be a base necessary for retaining an adherend when the adherend is applied to the adhesive layer, during heat treatment, and after cooling.

The (meth)acrylic tacky adhesive polymer can be obtained by polymerizing or copolymerizing a composition including a (meth)acrylic monomer and, as necessary, another monomer containing a monoethylenically-unsaturated group. In the present disclosure, the (meth)acrylic monomer and another monomer containing a monoethylenically-unsaturated group are collectively called “polymerizable components.” The tacky adhesive polymer means a polymer capable of imparting a pressure sensitive adhesive property to an adhesive agent at a temperature of use (for example, not less than 0° C. and not greater than 50° C.). The (meth)acrylic monomer and another monomer containing a monoethylenically-unsaturated group may each be used as one type or may be used as a combination of two or more types.

The (meth)acrylic monomer generally includes alkyl (meth)acrylate. The number of carbon atoms of the alkyl group of the alkyl (meth)acrylate may be from 1 to 12. Examples of the alkyl (meth)acrylate include methyl (meth)acrylate, ethyl (meth)acrylate, n-butyl (meth)acrylate, isobutyl (meth)acrylate, isoamyl (meth)acrylate, n-hexyl (meth)acrylate, n-octyl (meth)acrylate, isooctyl (meth)acrylate, 2-ethylhexyl (meth)acrylate, isononyl (meth)acrylate, decyl (meth)acrylate, isodecyl (meth)acrylate, dodecyl (meth)acrylate, cyclohexyl (meth)acrylate, 4-t-butyl cyclohexyl (meth)acrylate, and isobornyl (meth)acrylate. In an embodiment, n-butyl acrylate, 2-ethylhexyl acrylate, isooctyl acrylate, dodecyl acrylate, isobornyl (meth)acrylate, or a mixture thereof is used as the alkyl (meth)acrylate. These monomers can impart initial adhesive force to the adhesive layer.

The (meth)acrylic monomer or another monomer containing a monoethylenically-unsaturated group may include a polar monomer polymerizable with the alkyl (meth)acrylate. Examples of the polar monomer include a carboxy group-containing monomer such as (meth)acrylic acid, monohydroxyethyl phthalate (meth)acrylate, β-carboxyethyl (meth)acrylate, 2-(meth)acryloyloxyethyl succinic acid, 2-(meth)acryloyloxyethyl hexahydrophthalic acid, crotonic acid, itaconic acid, fumaric acid, citraconic acid, and maleic acid; an amino group-containing monomer such as aminoethyl (meth)acrylate, N,N-dimethylaminoethyl (meth)acrylate, and butylaminoethyl (meth)acrylate; an amide group-containing monomer such as (meth)acrylamide, N-vinyl pyrrolidone, and N-vinyl caprolactam; a hydroxy group-containing monomer such as 2-hydroxyethyl (meth)acrylate, 2-hydroxypropyl (meth)acrylate, and 4-hydroxybutyl (meth)acrylate; and unsaturated nitrile such as (meth)acrylonitrile. These polar monomers can increase cohesive force of the adhesive layer and improve adhesive force of the adhesive layer.

In an embodiment, the (meth)acrylic tacky adhesive polymer is a copolymer of a composition including, in terms of the polymerizable components, not less than approximately 2 mass %, not less than approximately 5 mass %, or not less than approximately 8 mass %, and not greater than approximately 50 mass %, not greater than approximately 40 mass %, and not greater than approximately 30 mass % of the polar monomer.

The (meth)acrylic monomer or another monomer containing a monoethylenically-unsaturated group may include an epoxy group-containing monomer. An example of the epoxy group-containing monomer includes glycidyl (meth)acrylate.

Examples of another monomer containing a monoethylenically-unsaturated group include an aromatic vinyl monomer such as styrene, α-methyl styrene, and vinyl toluene; and vinyl ester such as vinyl acetate.

The (meth)acrylic tacky adhesive polymer may contain at least one type of epoxy group-reactive functional group selected from a carboxy group, a hydroxy group, and an amino group. The epoxy group-reactive functional group of the (meth)acrylic tacky adhesive polymer may be present during heat treatment in the island portion or in the sea portion of the sea-island structure, and can react with the epoxy group of the self-crosslinking (meth)acrylic copolymer to increase cohesive force of an interface between the sea and the island of the sea-island structure, or to increase cohesive force of the sea portion. As a result, heat resistance of the adhesive layer as a whole can further be increased. The epoxy group-reactive functional group can be introduced into the (meth)acrylic tacky adhesive polymer by copolymerizing alkyl (meth)acrylate with a monomer containing an epoxy group-reactive functional group such as a carboxy group-containing monomer, a hydroxy group-containing monomer, or an amino group-containing monomer or an amide group-containing monomer containing active hydrogen on a nitrogen atom such as aminoethyl (meth)acrylate, butylaminoethyl (meth)acrylate, and (meth)acrylamide.

In an embodiment, the (meth)acrylic tacky adhesive polymer is a copolymer of a composition including, in terms of the polymerizable components, not less than approximately 50 mass % and not greater than approximately 98 mass % of alkyl (meth)acrylate and not less than approximately 2 mass % of a monomer containing an epoxy group-reactive functional group. The composition may include, in terms of the polymerizable components, not less than approximately 60 mass % or not less than approximately 70 mass %, and not greater than approximately 95 mass % or approximately 92 mass % of alkyl (meth)acrylate, and not less than approximately 5 mass % or not less than approximately 8 mass %, and not greater than approximately 50 mass %, not greater than approximately 40 mass %, or not greater than approximately 30 mass % of a monomer containing an epoxy group-reactive functional group.

In an embodiment, an acid value of the (meth)acrylic tacky adhesive polymer is not less than approximately 30 mg KOH/g, not less than approximately 35 mg KOH/g, or not less than approximately 40 mg KOH/g, and not greater than approximately 100 mg KOH/g, not greater than approximately 90 mg KOH/g, or not greater than approximately 80 mg KOH/g. Owing to the acid value of the (meth)acrylic tacky adhesive polymer being not less than approximately 30 mg KOH/g, reactivity of the (meth)acrylic tacky adhesive polymer with the epoxy group of the self-crosslinking (meth)acrylic copolymer can be increased. Owing to the acid value of the (meth)acrylic tacky adhesive polymer being not greater than approximately 100 mg KOH/g, cohesive force of the adhesive layer can be in an appropriate range and deterioration of the adhesive layer due to the presence of an acidic group, particularly deterioration in a high-temperature environment can be suppressed. The acid value of the (meth)acrylic tacky adhesive polymer can be determined by potentiometric titration using 0.1 M alcoholic potassium hydroxide as a titration reagent.

A weight average molecular weight of the (meth)acrylic tacky adhesive polymer is desirably high enough to phase-separate from the self-crosslinking (meth)acrylic copolymer to form the sea-island structure. In an embodiment, the weight average molecular weight of the (meth)acrylic tacky adhesive polymer is not less than approximately 300000, preferably not less than approximately 600000, and more preferably not less than approximately 1000000. The (meth)acrylic tacky adhesive polymer having such a high molecular weight can also advantageously increase heat resistance of an adhesive property. In an embodiment, the weight average molecular weight of the (meth)acrylic tacky adhesive polymer is not greater than approximately 5000000, not greater than approximately 4000000, or not greater than approximately 3000000. In the present disclosure, the “weight average molecular weight” means a molecular weight as measured by gel permeation chromatography (GPC) calibrated with polystyrene standard.

In an embodiment, the (meth)acrylic tacky adhesive polymer contains no epoxy group. As a result, miscibility of the (meth)acrylic tacky adhesive polymer and the self-crosslinking (meth)acrylic copolymer can be reduced and formation of the sea-island structure can be promoted.

In an embodiment, a glass transition temperature (Tg) of the (meth)acrylic tacky adhesive polymer is not less than approximately −30° C., not less than approximately −10° C., or not less than approximately 0° C., and not greater than approximately 50° C. or not greater than approximately 25° C. Owing to the Tg being in the above range, sufficient cohesive force and a sufficient adhesive property can be imparted to the adhesive layer in the temperature range of use of a heat resistant laminate.

The glass transition temperature Tg (° C.) of the (meth)acrylic tacky adhesive polymer can be determined by the following Fox equation, assuming that the polymer has been copolymerized from n types of monomers:

$$\frac{1}{Tg + 273.15} = {\sum }_{i = 1}^{n} ( \frac{{X}_{i}}{T {g}_{i} + 2 \; 73.15} ) \qquad [ Equation 1 ]$$

In the equation, Tgᵢ indicates a glass transition temperature (° C.) of a homopolymer of a component i, Xᵢ indicates a monomer mass content of the component i added during polymerization, and i is a natural number from 1 to n.

$${\sum }_{i = 1}^{n} {x}_{i} = 1 \qquad [ Equation 2 ]$$

The (meth)acrylic tacky adhesive polymer can be polymerized or copolymerized by radical polymerization, and a known polymerization method such as solution polymerization, suspension polymerization, emulsion polymerization, and block polymerization can be used. It is advantageous to use solution polymerization by which a high-molecular-weight polymer can be synthesized easily. Examples of a polymerization initiator that can be used include an organic peroxide such as benzoyl peroxide, lauroyl peroxide, and bis(4-tert-butylcyclohexyl)peroxydicarbonate; or an azo-based polymerization initiator such as 2,2′-azobisisobutyronitile, 2,2′-azobis(2-methylbutyronitrile), dimethyl-2,2-azobis(2-methylpropionate), 4,4′-azobis(4-cyanovaleric acid), dimethyl 2,2′-azobis(2-methylpropionate), and azobis(2,4-dimethylvaleronitrile) (AVN). A use amount of the polymerization initiator is generally not less than approximately 0.01 parts by mass or not less than approximately 0.05 parts by mass, and not greater than approximately 5 parts by mass or not greater than approximately 3 parts by mass, with respect to 100 parts by mass of the polymerizable components.

The self-crosslinking (meth)acrylic copolymer containing an epoxy group and an epoxy group-reactive functional group mainly constitutes the island of the sea-island structure. The self-crosslinking (meth)acrylic copolymer may be present in the sea of the sea-island structure.

When the self-crosslinking (meth)acrylic copolymer is placed in a high-temperature environment such as heat treatment, the epoxy group and the epoxy group-reactive functional group can react to form identical self-crosslinking (meth)acrylic copolymer molecules or a crosslinked structure between the self-crosslinking (meth)acrylic copolymer molecules (self-crosslinking). The self-crosslinking (meth)acrylic copolymer may not be crosslinked or may partially be crosslinked before heat treatment of the antistatic laminate. When the formation of the self-crosslinking advances in the high-temperature environment, cohesive force of the island increases, and as a result, heat resistance of the adhesive layer as a whole can further be increased. Furthermore, owing to the presence of the island having cohesive force increased by the self-crosslinking, adhesive force of the adhesive layer decreases in a temperature region lower than a peak temperature of heat treatment (for example, not greater than approximately 120° C.), and an adherend can be peeled easily from the adhesive layer and an adhesive agent residue present on the adherend obtained after the removal can be reduced or eliminated.

In a case where the (meth)acrylic tacky adhesive polymer contains an epoxy group-reactive functional group, the epoxy group of the self-crosslinking (meth)acrylic copolymer may be present in the sea portion of the sea-island structure or in the island portion of the sea-island structure during heat treatment, and can react with the epoxy group-reactive functional group of the (meth)acrylic tacky adhesive polymer to increase cohesive force of an interface between the island and the sea of the sea-island structure or to increase cohesive force of the island portion. As a result, heat resistance of the adhesive layer as a whole can further be increased.

As with the (meth)acrylic tacky adhesive polymer, the self-crosslinking (meth)acrylic copolymer can be obtained by copolymerizing a composition including a (meth)acrylic monomer and, as necessary, another monomer containing a monoethylenically-unsaturated group. The (meth)acrylic monomer and another monomer containing a monoethylenically-unsaturated group may each be used as one type or may be used as a combination of two or more types.

The (meth)acrylic monomer generally includes alkyl (meth)acrylate. The number of carbon atoms of an alkyl group of the alkyl (meth)acrylate may be from 1 to 12. Examples of the alkyl (meth)acrylate include methyl (meth)acrylate, ethyl (meth)acrylate, n-butyl (meth)acrylate, isobutyl (meth)acrylate, isoamyl (meth)acrylate, n-hexyl (meth)acrylate, n-octyl (meth)acrylate, isooctyl (meth)acrylate, 2-ethylhexyl (meth)acrylate, isononyl (meth)acrylate, decyl (meth)acrylate, isodecyl (meth)acrylate, dodecyl (meth)acrylate, cyclohexyl (meth)acrylate, 4-t-butyl cyclohexyl (meth)acrylate, and isobornyl (meth)acrylate. In an embodiment, ethyl acrylate, n-butyl acrylate, 2-ethylhexyl acrylate, cyclohexyl acrylate, 4-t-butylcyclohexyl acrylate, isobornyl (meth)acrylate, or a mixture thereof is used as the alkyl (meth)acrylate. These monomers can promote formation of the sea-island structure and can also impart initial adhesive force to the adhesive layer.

The (meth)acrylic monomer or another monomer containing a monoethylenically-unsaturated group includes an epoxy group-containing monomer, and as result, the epoxy group is introduced to the self-crosslinking (meth)acrylic copolymer. Examples of the epoxy group-containing monomer include glycidyl (meth)acrylate.

The (meth)acrylic monomer or another monomer containing a monoethylenically-unsaturated group includes a monomer containing an epoxy group-reactive functional group, and as a result, the epoxy group-reactive functional group is introduced into the self-crosslinking (meth)acrylic copolymer. Examples of the epoxy group-reactive functional group include a carboxy group, a hydroxy group, and an amino group.

Examples of the monomer containing an epoxy group-reactive functional group include a carboxy group-containing monomer such as (meth)acrylic acid, monohydroxyethyl phthalate (meth)acrylate, β-carboxyethyl (meth)acrylate, 2-(meth)acryloyloxyethyl succinic acid, 2-(meth)acryloyloxyethyl hexahydrophthalic acid, crotonic acid, itaconic acid, fumaric acid, citraconic acid, and maleic acid; a hydroxy group-containing monomer such as hydroxyalkyl (meth)acrylate such as 2-hydroxyethyl (meth)acrylate, 2-hydroxypropyl (meth)acrylate, and 4-hydroxybutyl (meth)acrylate; and an amino group-containing monomer or an amide group-containing monomer containing active hydrogen on a nitrogen atom such as aminoethyl (meth)acrylate, butylaminoethyl (meth)acrylate, and (meth)acrylamide. From the perspective of control of reactivity with the epoxy group, high adhesive force to the substrate, and high cohesive force, it is advantageous to use (meth)acrylic acid.

The epoxy group itself can also function as an epoxy group-reactive functional group.

The (meth)acrylic monomer or another monomer containing a monoethylenically-unsaturated group may include a dialkylamino group-containing monomer such as N,N-dimethylaminoethyl (meth)acrylate; an N-substituted amide group-containing monomer such as N-vinyl pyrrolidone and N-vinyl caprolactam; unsaturated nitrile such as (meth)acrylonitrile; an aromatic vinyl monomer such as styrene, α-methylstyrene, and vinyl toluene; or a vinyl ester such as vinyl acetate.

In an embodiment, the self-crosslinking (meth)acrylic copolymer is a copolymer of a composition including, in terms of the polymerizable components, not less than approximately 50 mass % and not greater than approximately 98 mass % of alkyl (meth)acrylate, not less than approximately 1 mass % of an epoxy group-containing monomer, and not less than approximately 1 mass % of a monomer containing an epoxy group-reactive functional group. However, a content of the monomer containing an epoxy group-reactive functional group does not include the epoxy group-containing monomer. The composition may include, in terms of the polymerizable components, not less than approximately 60 mass % or not less than approximately 70 mass %, and not greater than approximately 95 mass % or not greater than approximately 92 mass % of alkyl (meth)acrylate; not less than approximately 2 mass % or not less than approximately 4 mass %, and not greater than approximately 25 mass %, not greater than approximately 20 mass %, or not greater than approximately 15 mass % of an epoxy group-containing monomer; and not less than approximately 2 mass % or not less than approximately 4 mass %, and not greater than approximately 25 mass %, not greater than approximately 20 mass %, or not greater than approximately 15 mass % of a monomer containing an epoxy group-reactive functional group.

A weight average molecular weight of the self-crosslinking (meth)acrylic copolymer is desirably high enough to phase-separate from the (meth)acrylic tacky adhesive polymer to form the sea-island structure. In an embodiment, the weight average molecular weight of the self-crosslinking (meth)acrylic copolymer is not less than approximately 100000, preferably not less than approximately 300000, and more preferably not less than approximately 500000. The self-crosslinking (meth)acrylic copolymer having such a high molecular weight can also advantageously increase heat resistance of an adhesive property. In an embodiment, the weight average molecular weight of the self-crosslinking (meth)acrylic copolymer is not greater than approximately 2000000, not greater than approximately 1800000, or not greater than approximately 1500000.

In an embodiment, a glass transition temperature (Tg) of the self-crosslinking (meth)acrylic copolymer is not less than approximately −30° C., not less than approximately −10° C., or not less than approximately 0° C., and not greater than approximately 100° C., not greater than approximately 50° C., or not greater than approximately 25° C. Owing to the Tg being in the above range, sufficient cohesive force and a sufficient adhesive property can be imparted to the adhesive layer in the temperature range of use of the antistatic laminate. In a case where the Tg of the self-crosslinking (meth)acrylic copolymer is greater than approximately 100° C., the self-crosslinking (meth)acrylic copolymer is mixed with the (meth)acrylic tacky adhesive polymer having the Tg of not greater than approximately 25° C. and undergoes phase separation and thus, sufficient cohesive force and a sufficient adhesive property can be imparted to the adhesive layer. The glass transition temperature Tg (° C.) of the self-crosslinking (meth)acrylic copolymer can be determined by the Fox equation, as with the (meth)acrylic tacky adhesive polymer.

The self-crosslinking (meth)acrylic copolymer can be copolymerized by radical polymerization, and a known polymerization method such as solution polymerization, suspension polymerization, emulsion polymerization, and block polymerization can be used. It is advantageous to use solution polymerization by which a high-molecular-weight polymer can be synthesized easily. A type and a use amount of a polymerization initiator are the same as those described for the (meth)acrylic tacky adhesive polymer.

Composition, a weight average molecular weight, a compounding amount, and the like of each of the (meth)acrylic tacky adhesive polymer and the self-crosslinking (meth)acrylic copolymer can be adjusted to reduce miscibility of the (meth)acrylic tacky adhesive polymer and the self-crosslinking (meth)acrylic copolymer to a degree suitable for formation of the sea-island structure. The sea may contain the self-crosslinking (meth)acrylic copolymer within the range where the self-crosslinking (meth)acrylic copolymer dissolves in the (meth)acrylic tacky adhesive polymer, or the sea may not contain the self-crosslinking (meth)acrylic copolymer. The island may contain the (meth)acrylic tacky adhesive polymer within the range where the island is formed, or the island may not contain the (meth)acrylic tacky adhesive polymer.

In an embodiment, a mass ratio of the (meth)acrylic tacky adhesive polymer and the self-crosslinking (meth)acrylic copolymer is from 99:1 to 51:49, preferably from 90:10 to 51:49, and more preferably from 85:15 to 55:45. Owing to the mass ratio of the (meth)acrylic tacky adhesive polymer and the self-crosslinking (meth)acrylic copolymer being in the above range, formation of the sea-island structure can be promoted.

The (meth)acrylic tacky adhesive polymer, the self-crosslinking (meth)acrylic copolymer, or both the (meth)acrylic tacky adhesive polymer, and the self-crosslinking (meth)acrylic copolymer may be crosslinked by using a crosslinking agent. These polymers are crosslinked by using a crosslinking agent and as a result, cohesive force of the adhesive layer can be increased to increase heat resistance of the adhesive layer, and adhesive force at a high temperature can be maintained. Examples of the crosslinking agent include a bisamide-based crosslinking agent such as 1,1′-isophthaloylbis(2-methylaziridine); an aziridine-based crosslinking agent such as Chemitite (trade name) PZ33 (available from Nippon Shokubai Co., Ltd., Osaka, Japan); a carbodiimide-based crosslinking agent such as Carbodilite (trade name) V-03, V-05, and V-07 (all available from Nisshinbo Chemical Inc., Chuo-ku, Tokyo, Japan); an epoxy-based crosslinking agent such as E-AX, E-5XM, and E5C (all available from Soken Chemical & Engineering Co., Ltd., Toshima-ku, Tokyo, Japan) and N,N,N′,N′-tetraglycidyl-1,3-benzenedi(methanamine); and an isocyanate-based crosslinking agent such as Coronate (trade name) L and Coronate (trade name) HK (both available from Tosoh Corporation, Minato-ku, Tokyo, Japan).

A use amount of the crosslinking agent can be not less than approximately 0.01 parts by mass, not less than approximately 0.02 parts by mass, or not less than approximately 0.05 parts by mass, and not greater than approximately 2 parts by mass, not greater than approximately 1.5 parts by mass, or not greater than approximately 1 part by mass, with respect to 100 parts by mass of a total of the (meth)acrylic tacky adhesive polymer and the self-crosslinking (meth)acrylic copolymer. Owing to the use amount of the crosslinking agent being in the above range, cohesive force of the adhesive layer can be increased effectively.

The (meth)acrylic tacky adhesive polymer, the self-crosslinking (meth)acrylic copolymer, or both the (meth)acrylic tacky adhesive polymer, and the self-crosslinking (meth)acrylic copolymer may be crosslinked by copolymerization with a crosslinking monomer. Owing to crosslinking, cohesive force of the adhesive layer can be increased, heat resistance of the adhesive layer can be increased, and adhesive force at a high temperature can be maintained. Examples of the crosslinking monomer include polyfunctional (meth)acrylate such as 1,6-hexanediol di(meth)acrylate, 1,12-dodecanediol di(meth)acrylate, trimethylolpropane tri(meth)acrylate, pentaerythritol tetra(meth)acrylate, and 1,2-ethylene glycol di(meth)acrylate. The copolymerization with the crosslinking monomer can be performed by using a thermal polymerization initiator or a photopolymerization initiator. The copolymerization with the crosslinking monomer may be performed during preparation of the (meth)acrylic tacky adhesive polymer or the self-crosslinking (meth)acrylic copolymer or may be performed after preparation of the (meth)acrylic tacky adhesive polymer or the self-crosslinking (meth)acrylic copolymer, and by using an ethylenically unsaturated group remaining in these polymers.

A use amount of the crosslinking monomer can be not less than approximately 0.05 parts by mass, not less than approximately 0.1 parts by mass, or not less than approximately 0.2 parts by mass, and not greater than approximately 1 part by mass, not greater than approximately 0.8 parts by mass, or not greater than approximately 0.5 parts by mass, with respect to 100 parts by mass of a total of the (meth)acrylic tacky adhesive polymer and the self-crosslinking (meth)acrylic copolymer. Owing to the use amount of the crosslinking monomer being in the above range, cohesive force of the adhesive layer can be increased effectively.

The ionic liquid containing an epoxy group-reactive functional group (also referred to simply as an “ionic liquid” in the present disclosure) functions as an antistatic agent, and can impart an antistatic property to the adhesive layer. Furthermore, the ionic liquid containing an epoxy group-reactive functional group forms a chemical bond with the self-crosslinking (meth)acrylic copolymer during heat treatment and as a result, bleeding of the ionic liquid from the adhesive layer can be suppressed, and an antistatic property can be maintained even in a high-temperature environment. Furthermore, generation of an adhesive agent residue associated with the bleeding of the ionic liquid can be suppressed, and when an adherend is peeled from the adhesive layer after heat treatment, the adhesive agent residue present on the adherend can be reduced or eliminated effectively.

As the ionic liquid, an ionic liquid including a non-polymeric onium cation and a weakly coordinating organic anion can be used. The epoxy group-reactive functional group of the ionic liquid may be present in the onium cation, or may be present in the weakly coordinating organic anion, or may be present in both the onium cation and the weakly coordinating organic anion. In an embodiment, the epoxy group-reactive functional group is present in the onium cation.

Examples of the onium cation include a cyclic or noncyclic nitrogen-containing onium cation, a sulfonium cation, and a phosphonium cation. In an embodiment, the onium cation is an ammonium cation containing an epoxy group-reactive functional group, for example, a hydroxyalkyl group.

A Hammett acidity function Ho of a conjugate acid of the weakly coordinating organic anion is generally not greater than approximately −7, not greater than approximately −10, or not greater than approximately −12. The weakly coordinating organic anion is generally a fluorine-containing organic anion, and advantageously contains at least one perfluoroalkane sulfonyl group or at least one partial fluoroalkane sulfonyl group. Examples of the weakly coordinating organic anion include perfluoroalkane sulfonate, cyanoperfluoroalkane sulfonylamide, bis(cyano)perfluoroalkane sulfonylmethide, bis(perfluoroalkane sulfonyl)imide, bis(perfluoroalkane sulfonyl)methide, and tris(perfluoroalkane sulfonyl)methide. The weakly coordinating organic anion is desirably perfluoroalkane sulfonate, bis(perfluoroalkane sulfonyl)imide, or tris(perfluoroalkane sulfonyl)methide, more desirably bis(perfluoroalkane sulfonyl)imide or tris(perfluoroalkane sulfonyl)methide, and particularly desirably bis(perfluoroalkane sulfonyl)imide.

The epoxy group-reactive functional group of the ionic liquid may be at least one selected from a carboxy group, a hydroxy group, an amino group, and an epoxy group. In an embodiment, from the perspective of ease of synthesis and availability of the ionic liquid, the epoxy group-reactive functional group of the ionic liquid is a hydroxy group.

Examples of the ionic liquid include:

octyldimethyl-2-hydroxyethylammonium bis(trifluoromethylsulfonyl)imide: [C₈H₁₇N⁺(CH₃)₂CH₂CH₂OH⁻N(SO₂CF₃)₂],

octyldimethyl-2-hydroxyethylammonium perfluorobutane sulfonate: [C₈H₁₇N⁺(CH₃)₂CH₂CH₂OH⁻OSO₂C₄F₉],

octyldimethyl-2-hydroxyethylammonium trifluoromethane sulfonate: [C₈H₁₇N⁺(CH₃)₂CH₂CH₂OH⁻OSO₂CF₃],

octyldimethyl-2-hydroxyethylammonium tris(trifluoromethane sulfonyl)methide: [C₈H₁₇N⁺(CH₃)₂CH₂CH₂OH⁻C(SO₂CF₃)₃],

trimethyl-2-hydroxyethylammonium bis(perfluorobutane sulfonyl)imide: [(CH₃)₃N⁺CH₂CH₂OH⁻N(SO₂C₄F₉)₂],

octyldimethyl-2-hydroxyethylammonium trifluoromethane sulfonyl perfluorobutane sulfonylimide: [C₈H₁₇N⁺(CH₃)₂CH₂CH₂OH⁻N(SO₂CF₃)(SO₂C₄F₉)],

trimethyl-2-hydroxyethylammonium trifluoromethane sulfonyl perfluorobutane sulfonylimide: [(CH₃)₃N⁺CH₂CH₂OH⁻N(SO₂CF₃)(SO₂C₄F₉)], and

octyldimethyl-2-hydroxyethylammonium bis(cyano)trifluoromethane sulfonylmethide: [C₈H₁₇N⁺(CH₃)₂CH₂CH₂OH⁻C(CN)₂(SO₂CF₃)]

The ionic liquid is a liquid under the conditions of use, and has a melting point of, for example, not greater than approximately 150° C., not greater than approximately 50° C., or not greater than approximately 25° C. The ionic liquid is desirably stable at a temperature of not less than approximately 325° C. or not less than approximately 350° C., that is, the ionic liquid desirably does not break down up to that temperature.

A use amount of the ionic liquid can be not less than approximately 0.1 parts by mass, not less than approximately 0.2 parts by mass, or not less than approximately 0.5 parts by mass, and not greater than approximately 10 parts by mass, not greater than approximately 5 parts by mass, or not greater than approximately 3 parts by mass, with respect to 100 parts by mass of a total of the self-crosslinking (meth)acrylic copolymer and any (meth)acrylic tacky adhesive polymer. Owing to the use amount of the ionic liquid being not less than approximately 0.1 parts by mass with respect to 100 parts by mass of a total of the self-crosslinking (meth)acrylic copolymer and any (meth)acrylic tacky adhesive polymer, an antistatic property of the adhesive layer can be increased effectively. Owing to the use amount of the ionic liquid being not greater than approximately 10 parts by mass with respect to 100 parts by mass of a total of the self-crosslinking (meth)acrylic copolymer and any (meth)acrylic tacky adhesive polymer, an amount of the ionic liquid remaining without forming a chemical bond with the self-crosslinking (meth)acrylic copolymer after heat treatment can be reduced, and contaminants such as the ionic liquid and an adhesive agent residue present on an adherend can be reduced or eliminated more effectively.

The adhesive layer may include an additive such as a filler such as talc, kaolin, calcium carbonate, aluminum flake, fumed silica, alumina, and nanoparticles; an antioxidant; and an adhesion imparting agent.

The presence and dimensions of the sea-island structure of the adhesive layer can be measured by using an atomic force microscope. In an embodiment, a maximum diameter of the island is not less than approximately 20 nm, not less than approximately 100 nm, or not less than approximately 200 nm, and not greater than approximately 20 μm, not greater than approximately 10 μm, or not greater than approximately 1 μm. In the present disclosure, the “maximum diameter” means the Krumbein diameter (maximum diameter in a specified direction).

A thickness of the adhesive layer may vary according to application, and can be, for example, not less than approximately 1 μm, not less than approximately 5 μm, or not less than approximately 25 μm, and not greater than approximately 250 μm, not greater than approximately 100 μm, or not greater than approximately 50 μm.

In an embodiment, surface resistance of the adhesive layer is, as measured under conditions of 23° C. and relative humidity of 55%, not less than approximately 1×10³Ω/□, not less than approximately 1×10⁵Ω/□, or not less than approximately 1×10⁶Ω/□, and not greater than approximately 1×10¹²Ω/□, not greater than approximately 1×10¹⁰Ω/□, or not greater than approximately 1×10⁹Ω/□.

In an embodiment, initial adhesive force of the antistatic laminate is not less than approximately 0.3 N/cm, preferably not less than approximately 0.5 N/cm, and more preferably not less than approximately 1.0 N/cm, as measured under conditions of causing the antistatic laminate to adhere to a copper plate and peeling the antistatic laminate at a temperature of 23° C. by 180 degree peeling at a peeling speed of 300 mm/minute. Owing to the initial adhesive force of the antistatic laminate measured under the above conditions being not less than approximately 0.3 N/cm, an adherend can be secured sufficiently to a work surface of SUS, quartz glass, or the like. In an embodiment, the initial adhesive force of the antistatic laminate is not greater than approximately 4 N/cm, not greater than approximately 3 N/cm, or not greater than approximately 2 N/cm, as measured under the above conditions,

In an embodiment, peel strength obtained after heat treatment of the antistatic laminate is not less than approximately 0.1 N/cm, preferably not less than approximately 1 N/cm, and more preferably not less than approximately 1.5 N/cm, as measured under conditions where the antistatic laminate is adhered to a copper plate and left to stand at 270° C. for 5 minutes, and then at 200° C. for 1 hour, and subsequently peeled at a temperature of 23° C. by 180 degree peeling at a peeling speed of 300 mm/minute. Owing to the peel strength obtained after heat treatment of the antistatic laminate as measured under the above conditions being not less than approximately 0.1 N/cm, adhesive force sufficient to secure an adherend to a work surface during heat treatment can be obtained. In an embodiment, the peel strength obtained after heat treatment of the antistatic laminate is not greater than approximately 3.0 N/cm, not greater than approximately 2 N/cm, or not greater than approximately 1.8 N/cm, as measured under the above conditions, Owing to the peel strength obtained after heat treatment of the antistatic laminate as measured under the above conditions being not greater than approximately 3.0 N/cm, an adherend can be peeled easily from the adhesive layer, and an adhesive agent residue present on the adherend obtained after the removal can be reduced or eliminated.

In an embodiment, a difference between the initial adhesive force of the antistatic laminate and the peel strength obtained after heat treatment of the antistatic laminate is not greater than approximately 1.0 N/cm, not greater than approximately 0.9 N/cm, or not greater than approximately 0.5 N/cm.

In an embodiment, a mass loss of the antistatic laminate is not greater than approximately 10 mass %, not greater than approximately 8 mass %, or not greater than approximately 5 mass % after heat treatment at 200° C. for 1 hour.

The antistatic laminate may include a second adhesive layer on the substrate surface of the side opposite to the substrate surface on which the above adhesive layer is disposed. The second adhesive layer may be the same as the above adhesive layer, and may be formed by using an adhesive agent generally used such as a solvent type adhesive agent, an emulsion type adhesive agent, a pressure sensitive type adhesive agent, a heat-sensitive type adhesive agent, and a heat-curable or ultraviolet-curable adhesive agent of (meth)acrylic, polyolefin, polyurethane, polyester, rubber, and the like. A thickness of the second adhesive layer is generally not less than approximately 5 μm, not less than approximately 10 μm, or not less than approximately 20 μm, and not greater than approximately 200 μm, not greater than approximately 100 μm, or not greater than approximately 80 μm.

A release liner may be disposed on the above adhesive layer, the above second adhesive layer, or both the adhesive layer and the second adhesive layer. Examples of the release liner include a sheet or a film of paper (for example, kraft paper) or of a polymer material (for example, polyolefin such as polyethylene and polypropylene; and polyester such as ethylene vinyl acetate, polyurethane, and polyethylene terephthalate). The release liner may be release-treated with a release agent containing silicone, a long-chain alkyl compound, a fluorine compound, or the like. A thickness of the release liner is generally not less than approximately 5 μm, not less than approximately 15 μm, or not less than approximately 25 μm, and not greater than approximately 300 μm, not greater than approximately 200 μm, or not greater than approximately 150 μm.

In an embodiment, the antistatic laminate or the adhesive layer of the antistatic laminate is used in a high-temperature environment of 100° C. or greater. For example, heat treatment is performed at a temperature of 100° C. to 270° C. for 5 to 10 minutes in the solder reflow step, and at a temperature of 200° C. for 30 minutes to 2 hours in the epoxy molding compound curing step. The antistatic laminate or the adhesive layer of the antistatic laminate can be used favorably in such a high-temperature heat treatment step.

The antistatic laminate may be used favorably as a process tape for temporary adhesion in the production step of an electronic component and the like. Since the antistatic laminate can be formed of a non-siloxane material, an issue such as a contact failure occurring due to volatile low-molecular-weight siloxane attaching to an electronic component or the like during heat treatment can be avoided.

### EXAMPLES

In the following examples, specific embodiments of the present disclosure are described as examples, but the present invention is not limited to these embodiments. All “parts” and “percent” are based on mass unless specified otherwise.

Reagents and materials used in the present examples are shown in Table 1.

TABLE 1

| Product name, | | |
|---|---|---|
| designation, or | | |
| abbreviation | Description | Supplier |
| Acrylic tacky | IOA/AA = 90/10, solid content 18%, | — |
| adhesive polymer | toluene/ethyl acetate solution, Mw | |
| | 1200000 | |
| Self-crosslinking | 2EHA/AA/GMA = 89/3.7/7.3, solid | — |
| acrylic copolymer | content 29%, toluene/ethyl acetate | |
| | solution, Irganox (trade name) 1330 | |
| | content 1 mass %, Mw 600000 | |
| IOA | Isooctyl acrylate | BASF Japan |
| | | (Minato-ku, |
| | | Tokyo, Japan) |
| AA | Acrylic acid | BASF Japan |
| | | (Minato-ku, |
| | | Tokyo, Japan) |
| 2EHA | 2-ethylhexyl acrylate | Nippon |
| | | Shokubai Co, |
| | | Ltd. |
| | | (Osaka City, |
| | | Osaka |
| | | Prefecture, |
| | | Japan) |
| GMA | Glycidyl methacrylate | NOF |
| | | Corporation |
| | | (Shibuya-ku, |
| | | Tokyo, Japan) |
| IPBMA | 1,1′- | — |
| | isophthaloylbis(2-methylaziridine), | |
| | 3% toluene solution | |
| FC-4400 | Ionic liquid, Rf₄N⁺(CF₃SO₂)₂N⁻ | 3M Japan |
| | | Limited |
| | | (Minato-ku, |
| | | Tokyo, Japan) |
| HQ-115 | Ionic liquid, containing Li⁺ ions | 3M Japan |
| | | Limited |
| | | (Minato-ku, |
| | | Tokyo, Japan) |
| FC-5000 | Ionic liquid, | 3M Japan |
| | Rf₃(R—OH)N⁺(CF₃SO₂)₂N⁻ | Limited |
| | | (Minato-ku, |
| | | Tokyo, Japan) |
| Irganox (trade | Antioxidant | BASF Japan |
| name) 1330 | | (Minato-ku, |
| | | Tokyo, Japan) |
| Irganox (trade | Antioxidant | BASF Japan |
| name) 1010 | | (Minato-ku, |
| | | Tokyo, Japan) |

Preparation of Pressure Sensitive Adhesive Solution A-0

59 g of an acrylic tacky adhesive copolymer, 25.1 g of a self-crosslinking acrylic copolymer, 3.4 g of a crosslinking agent 1,1′-isophthaloylbis(2-methylaziridine) (IPBMA), and 0.1 g of an antioxidant Irganox (trade name) 1010 were mixed in a glass bottle. The mixture was diluted with methyl ethyl ketone (MEK) to prepare a pressure sensitive adhesive solution A-0 having a solid content of 18%.

Preparation of Pressure Sensitive Adhesive Solutions A-1 to A-3

2.5 parts by mass or 2.0 parts by mass of each of ionic liquids shown in Table 2 with respect to 100 parts by mass of a total of the acrylic tacky adhesive polymer and the self-crosslinking acrylic copolymer was added to the pressure sensitive adhesive agent solution A-0, and was mixed again to prepare each of pressure sensitive adhesive agent solutions A1 to A3.

Preparation of Pressure Sensitive Adhesive Solution B

100 g of a self-crosslinking acrylic copolymer and 2.5 g of an ionic liquid FC-5000 were mixed in a glass bottle to prepare a pressure sensitive adhesive agent solution B.

Metallized Polyimide Film Substrate

A metallized polyimide film substrate was produced by sputtering a surface of a polyimide (PI) film having a thickness of 25 μm (Kapton (trade name) 100H, available from Du Pont-Toray Co., Ltd. (Chuo-ku, Tokyo, Japan)) by using an Al or Ti target material. Surface resistance of the metallized surface was from 0.041 to 15 kΩ/□, as measured under conditions of room temperature (23° C.) and relative humidity of 55%.

### Examples 1 to 5, Comparative Examples 1 to 4

Each antistatic laminate including a pressure sensitive adhesive layer was produced by the following procedure. A metallized or unmetallized polyimide (PI) film having a thickness of 25 μm (Kapton (trade name) 100H, available from Du Pont-Toray Co., Ltd. (Chuo-ku, Tokyo, Japan)) was used as a film substrate of the antistatic laminate. A pressure sensitive adhesive solution was cast on a surface of the film substrate, and dried in an oven at 65° C. for 2 minutes and at 110° C. for 2 minutes. A cast amount was adjusted to obtain a dry thickness of the pressure sensitive adhesive layer of 17 μm. A silicone-coated PET film having a thickness of 38 μm (Cerapeel (trade name) BKE, available from Toray Advanced Film Co., Ltd. (Chuo-ku, Tokyo, Japan)) was laminated as a release liner on the pressure sensitive adhesive layer, and the laminate was placed in a 90° C. oven for 3 days. In this manner, an antistatic laminate including a release liner on the pressure sensitive adhesive layer was produced.

The antistatic laminate was evaluated with regard to the following items.

Initial Adhesive Force

After the release liner of the antistatic laminate was peeled, the antistatic laminate was adhered to a copper plate (C1100P, length 100 mm×width 50 mm×thickness 1 mm) at room temperature (23° C.). A 2 kg rubber roller was rolled back and forth twice on the antistatic laminate to compression-bond the antistatic laminate to the copper plate, and the antistatic laminate was left to stand at 23° C. for 20 minutes. 180 degree adhesive force was measured by using a tensile tester under conditions of room temperature (23° C.) and 300 mm/minute, and was assumed to be initial adhesive force.

Peel Strength Obtained after Heat Treatment

The release liner of the antistatic laminate was removed, and the antistatic laminate was adhered to a copper plate (C1100P, length 100 mm×width 50 mm×thickness 1 mm) at room temperature (23° C.). A 2 kg rubber roller was rolled back and forth twice on the antistatic laminate to compression-bond the antistatic laminate to the copper plate, and the antistatic laminate was left to stand at 270° C. for 5 minutes and then aged at 200° C. for 1 hour. After the antistatic laminate was cooled to room temperature (23° C.), 180 degree adhesive force was measured by using a tensile tester under conditions of room temperature (23° C.) and 300 mm/minute, and was assumed to be peel strength obtained after heat treatment. Furthermore, the presence or absence of a pressure sensitive adhesive residue on a copper plate surface obtained after peeling was observed under a microscope at 20×. When no residue was observed, the peel strength was evaluated as “good” and when the residue was observed, the peel strength was evaluated as “poor.”

Electrostatic Discharge (ESD) Measurement A

An initial electrostatic charge due to peeling of the pressure sensitive adhesive layer of the antistatic laminate from a metal plate was measured by the following procedure.

(1) The antistatic laminate was cut into a 25 mm×50 mm rectangular shape and the release liner was removed to produce a measurement sample.

(2) The sample was bonded onto a metal stage of a 3M (trade name) charge plate monitor 3M711 (available from 3M Japan Limited (Shinagawa-ku, Tokyo, Japan)).

(3) After the bonding of the sample, a charge was accumulated for 30 seconds, and a monitor table was grounded to reach 0 V.

(4) The sample was peeled from the metal stage at a speed of 30 m/minute, and was charged, and a charge amount was measured.

(5) An average value of values obtained by measuring the charge amount of the same sample three times was assumed to be the electrostatic charge.

Electrostatic Discharge (ESD) Measurement B

Discharge mitigation due to grounding an end portion of the pressure sensitive adhesive layer was measured by the following procedure.

(1) The antistatic laminate was cut into a 25 mm×45 mm rectangular shape, and a polyimide film substrate surface was bonded to a 3M (trade name) electrically conductive tape X7001 (available from 3M Japan Limited (Shinagawa-ku, Tokyo, Japan)).

(2) The X7001 was bonded onto a metal stage of a 3M charge plate monitor 3M711 (available from 3M Japan Limited (Shinagawa-ku, Tokyo, Japan)).

(3) A metal clip was secured to an end portion of the antistatic laminate to come into contact with the pressure sensitive adhesive layer of the antistatic laminate, and a monitor table was grounded to reach 0 V.

(4) The release liner was peeled from the pressure sensitive adhesive layer of the antistatic laminate at a speed of 30 m/minute, and the antistatic laminate was charged to measure a charge amount during 60 seconds.

(5) An average value of values obtained by measuring the charge amount of the same sample twice was assumed to be the discharge mitigation.

Evaluation Results

The presence or absence of metallization of the substrate and surface resistance, compounding of the pressure sensitive adhesive solution, and evaluation results excluding the electrostatic discharge (ESD) measurement B are shown in Table 2. Evaluation results of the electrostatic discharge (ESD) measurement B are shown in Table 3.

TABLE 2

| | | | | | | | | Heat treatment | | |
|---|---|---|---|---|---|---|---|---|---|---|
| | | Surface | Pressure | | | | Initial | (200° C., 1 hour) | | ESD |
| | PI film | resistance of | sensitive | | | | adhesive | Peel | Adhesive | measurement A |
| | substrate | substrate¹⁾ | adhesive | Ionic liquid²⁾ | | | force | strength | agent | electrostatic |
| | metallization | (kΩ/□) | solution | FC-5000 | FC-4400 | HQ-115 | (N/cm) | (N/cm) | residue | charge (V/m²) |
| Example 1 | No | >1000 | A-1 | 2.5 | — | — | 0.7 | 0.8 | Good | 0.148 |
| Example 2 | Ti | 0.54 | A-1 | 2.5 | — | — | 0.9 | 1.1 | Good | 0.002 |
| Example 3 | Ti | 15 | A-1 | 2.5 | — | — | — | — | — | 0.000 |
| Example 4 | Al | 4.9 | A-1 | 2.5 | — | — | — | — | — | 0.002 |
| Example 5 | Al | 0.041 | A-1 | 2.5 | — | — | — | — | — | 0.017 |
| Comparative | No | >1000 | A-0 | — | — | — | 0.5 | 0.7 | Good | 0.301 |
| Example 1 | | | | | | | | | | |
| Comparative | No | >1000 | A-2 | — | 2 | — | 1.2 | 2.1 | Poor | 0.000 |
| Example 2 | | | | | | | | | | |
| Comparative | No | >1000 | A-3 | — | — | 2 | 1.3 | 2.3 | Poor | 0.000 |
| Example 3 | | | | | | | | | | |
| Comparative | No | >1000 | B | 2.5 | — | — | 0.2 | 1.5 | Poor | 0.000 |
| Example 4 | | | | | | | | | | |

¹⁾As for metallized PI films, metallized surfaces were measured
²⁾A numeric value is indicated in terms of parts by mass with respect to 100 parts by mass of a total of the acrylic tacky adhesive polymer and the self-crosslinking acrylic copolymer

TABLE 3

| | | | | | | | Electrostatic |
|---|---|---|---|---|---|---|---|
| | | | | | | | charge (60 sec)/ |
| | ESD measurement B discharge mitigation (V/m²) | | | | | | electrostatic |
| | 1 sec | 10 sec | 20 sec | 30 sec | 45 sec | 60 sec | charge (1 sec) |
| Example 1 | 0.324 | 0.094 | 0.037 | 0.022 | 0.008 | 0.002 | 0.6% |
| Example 2 | 0 | 0 | 0 | 0 | 0 | 0 | — |
| Example 3 | 0 | 0 | 0 | 0 | 0 | 0 | — |
| Example 4 | 0 | 0 | 0 | 0 | 0 | 0 | — |
| Example 5 | 0 | 0 | 0 | 0 | 0 | 0 | — |
| Comparative | 0.372 | 0.188 | 0.148 | 0.131 | 0.115 | 0.100 | 27% |
| Example 1 | | | | | | | |

It is obvious to a person skilled in the art that various improvements and modifications of the present invention can be made without deviating from the scope and the spirit of the present invention.

### REFERENCE SIGNS LIST

10 Antistatic laminate
12 Substrate
14 Adhesive layer
142 Ionic liquid containing epoxy group-reactive functional group
144 Sea
146 Island
16 Second adhesive layer
18 Electrically conductive layer

1. An antistatic laminate comprising a substrate and an adhesive layer, wherein
the adhesive layer includes:
a (meth)acrylic tacky adhesive polymer;
a self-crosslinking (meth)acrylic copolymer containing an epoxy group and an epoxy group-reactive functional group; and
an ionic liquid containing an epoxy group-reactive functional group; and
the adhesive layer includes a sea-island structure including a sea containing the (meth)acrylic tacky adhesive polymer and an island containing the self-crosslinking (meth)acrylic copolymer.

2. The laminate according to claim 1, wherein the (meth)acrylic tacky adhesive polymer is a copolymer of a composition including, in terms of polymerizable components, from 50 to 98 mass % of alkyl (meth)acrylate and not less than 2 mass % of a monomer containing an epoxy group-reactive functional group.

3. The laminate according to claim 1, wherein the adhesive layer includes the (meth)acrylic tacky adhesive polymer and the self-crosslinking (meth)acrylic copolymer at a mass ratio of 99:1 to 51:49.

4. The laminate according to claim 1, wherein the self-crosslinking (meth)acrylic copolymer is a copolymer of a composition including, in terms of polymerizable components, from 50 to 98 mass % of alkyl (meth)acrylate, not less than 1 mass % of an epoxy group-containing monomer, and not less than 1 mass % of a monomer containing an epoxy group-reactive functional group.

5. The laminate according to claim 1, to wherein the adhesive layer includes from 0.5 to 5 mass % of the ionic liquid.

6. An antistatic adhesive agent comprising:
a (meth)acrylic tacky adhesive polymer;
a self-crosslinking (meth)acrylic copolymer containing an epoxy group and an epoxy group-reactive functional group; and
an ionic liquid containing an epoxy group-reactive functional group;
wherein
when the antistatic adhesive agent is solidified or dried on a substrate, the antistatic adhesive agent forms a sea-island structure including a sea containing the (meth)acrylic tacky adhesive polymer and an island containing the self-crosslinking (meth)acrylic copolymer.

7. The adhesive agent according to claim 6, wherein the (meth)acrylic tacky adhesive polymer is a copolymer of a composition including, in terms of polymerizable components, from 50 to 98 mass % of alkyl (meth)acrylate and not less than 2 mass % of a monomer containing an epoxy group-reactive functional group.

8. The adhesive agent according to claim 6, comprising the (meth)acrylic tacky adhesive polymer and the self-crosslinking (meth)acrylic copolymer at a mass ratio of 99:1 to 51:49.

9. The adhesive agent according to claim 6, wherein the self-crosslinking (meth)acrylic copolymer is a copolymer of a composition including, in terms of polymerizable components, from 50 to 98 mass % of an alkyl (meth)acrylate, not less than 1 mass % of an epoxy group-containing monomer, and not less than 1 mass % of a monomer containing an epoxy group-reactive functional group.

10. The adhesive agent according to claim 6, comprising from 0.5 to 5 mass % of the ionic liquid.
